(19) United States
(12) Patent Application Publication
(10) Pub. No.: US 2019/0266679 A1
(43) Pub. Date: Aug. 29, 2019

(54) SEAT GUIDING APPARATUS, SEAT GUIDING PROGRAM, AND SEAT GUIDING METHOD

(71) Applicant: ZENSHO HOLDINGS CO., LTD., Tokyo (JP)

(72) Inventors: Tatsuya IKENOUE, Tokyo (JP); Takuro HASHIO, Tokyo (JP)

(73) Assignee: Zensho Holdings Co., Ltd., Tokyo (JP)

(21) Appl. No.: 16/309,643

(22) PCT Filed: Jun. 13, 2017
(86) PCT No.: PCT/JP2017/021817

§ 371 Date: Dec. 13, 2018

(30) Foreign Application Priority Data
Jun. 14, 2016 (JP) 2016-117980

(51) Int. Cl. G06Q 50/12; G06Q 30/06; G06Q 10/02

(52) U.S. Cl. CPC G06Q 50/12; G06Q 10/02; G06Q 30/0625

(57) ABSTRACT

A seat guiding apparatus includes: a conditions receiving unit that receives conditions of a desired seat; a first searching unit that searches for an unoccupied seat appropriate for the conditions received; a reservation registering unit that registers reservation data; a reservation information output unit that outputs reservation guidance data including the authentication information registered in the reservation data; a second searching unit that searches for an unoccupied seat appropriate for the conditions registered in the reservation data in updated seat data; an acquisition unit that acquires authentication information input by the user; an authentication processing unit determining that the authentication information acquired by the acquisition unit is input by an authorized user; and a guidance output unit that outputs information of a seat searched by the first searching unit as guidance data and outputs information of a seat searched by the second searching unit as guidance data.

### TECHNICAL FIELD

This disclosure relates to a seat guiding apparatus, a seat guiding program, and a seat guiding method of guiding a customer to a seat in an establishment such as a restaurant.

### BACKGROUND

In recent years, in establishments such as restaurants, technologies that automatically guide customers to seats have been developed. When all the seats inside an establishment are occupied, the establishment will be crowded, and members of staff may be busy in many cases.

For this reason, when a customer cannot immediately check the presence/absence of unoccupied seats with desired conditions with a member of staff when the customer visits the restaurant, and when the customer cannot confirm that all the seats are occupied and make a reservation using a seat guiding system, the customer can determine whether or not to wait in the restaurant or prepare to wait with peace of mind.

In addition, systems have also been developed that register a seat reservation at the time of all the seats being occupied or the like and guide a customer who has made a reservation and been waiting to a seat in an occurrence of a seat becoming vacant inside the restaurant (for example, see Japanese Unexamined Patent Application Publication No. 2000-040105).

However, when a customer who has been waiting for a seat to become vacant is guided to a seat by a system at the time of occurrence of a seat becoming vacant, correspondence between the customer who has actually made a reservation and has been waiting and a customer who is guided toward the seat may not be able to be checked. In other words, when a member of staff guides a customer who has been waiting for a seat to a seat, the member of staff may check whether a reserving person is a customer to be guided. However, in the system disclosed in JP '105, it is difficult to check whether a reserving person is a customer to be guided.

As described above, in a seat guiding system, it is difficult to correctly guide a reserving person, and there is concern that a different reserving person may be incorrectly guided to a seat.

It could therefore be helpful to provide a seat guiding apparatus that guides a user to a desired seat in an establishment such as a restaurant and is able to correctly guide a user to a seat by executing authentication of the user guided to the seat at a timing at which there is a state in which guidance to the seat can be performed in a case in which the user is waiting for a seat due to another customer sitting on the desired seat.

### SUMMARY

We thus provide a seat guiding apparatus including: a conditions receiving unit that receives conditions of a desired seat input by a user requesting an unoccupied seat in a restaurant; a first searching unit that searches for an unoccupied seat appropriate for the conditions received by the conditions receiving unit by referring to seat data including a state of each seat in the restaurant; a reservation registering unit that registers reservation data including authentication information given for authentication of the user and the conditions when a seat appropriate for the conditions is not searched by the first searching unit; a reservation information output unit that outputs reservation guidance data including the authentication information registered in the reservation data when the reservation registering unit registers the reservation data; a second searching unit that searches for an unoccupied seat appropriate for the conditions registered in the reservation data in updated seat data when the seat data is updated; an acquisition unit that acquires authentication information input by the user when a seat appropriate for the conditions is searched by the second searching unit; an authentication processing unit determining that the authentication information acquired by the acquisition unit has been input by an authorized user when the authentication information acquired by the acquisition unit matches the authentication information included in the reservation data; and a guidance output unit that outputs information of a seat searched by the first searching unit as guidance data when a seat appropriate for the conditions is searched by the first searching unit and outputs information of a seat searched by the second searching unit as guidance data when an input from the authorized user is authenticated by the authentication processing unit.

The seat guiding apparatus may further include a seat data updating unit that updates the seat data by changing a state of the seat to which the user is guided as being occupied in the guidance data when the guidance output unit outputs the guidance data.

The seat guiding apparatus may further include a reservation data updating unit that updates the reservation data by deleting the authentication information and the conditions of the user who for which the guidance data has been provided when the guidance output unit outputs the information of the seat searched by the second searching unit as the guidance data.

The seat guiding apparatus may further include a detection unit that detects an update of the seat data and notifies the second searching unit of the update of the seat data.

The reservation registering unit may register reservation data including a reservation number that specifies an order of a reservation, and the second searching unit may set a seat for conditions specified for a reservation which has been registered first using the reservation number included in the reservation data as a search target.

The seat guiding apparatus may further include an authentication information generating unit that generates authentication information used for authentication of the user and outputs the generated authentication information to the reservation information output unit when a seat appropriate for the conditions is searched by the second searching unit.

The reservation information output unit may print reservation information on a reservation sheet, transmit electronic data including the reservation information to a terminal of the user, or display a display screen including the reservation information on a display.

The guidance output unit may print guidance data on a guidance sheet, transmit electronic data including the guidance information to a terminal of the user, display a display screen including the guidance information on a display, or output speech data including the guidance information from a speaker.

We also provide a seat guiding program causing a seat guiding apparatus to execute: a condition receiving function of receiving conditions of a desired seat input by a user requesting an unoccupied seat in a restaurant; a first searching function of searching for an unoccupied seat appropriate for the conditions received by the condition receiving function by referring to seat data including a state of each seat in the restaurant; a reservation registering function of registering reservation data including authentication information given for authentication of the user and the conditions when a seat appropriate for the conditions is not searched by the first searching function; a reservation information output function of outputting reservation guidance data including the authentication information registered in the reservation data when the reservation registering function registers the reservation data; a second searching function of searching for an unoccupied seat appropriate for the conditions registered in the reservation data in updated seat data when the seat data is updated; an acquisition function of acquiring authentication information input by the user when a seat appropriate for the conditions is searched by the second searching function; an authentication processing function of determining that the authentication information acquired by the acquisition function has been input by an authorized user when the authentication information acquired by the acquisition function matches the authentication information included in the reservation data; and a guidance output function of outputting information of a seat searched by the first searching function as guidance data when a seat appropriate for the conditions is searched by the first searching function and outputting information of a seat searched by the second searching function as guidance data when an input from the authorized user is authenticated by the authentication processing function.

We further provide a seat guiding method including: a condition receiving step of receiving conditions of a desired seat input by a user requesting an unoccupied seat in a restaurant; a first searching step of searching for an unoccupied seat appropriate for the conditions received in the condition receiving step by referring to seat data including a state of each seat in the restaurant; a reservation registering step of registering reservation data including authentication information given for authentication of the user and the conditions when a seat appropriate for the conditions is not searched in the first searching step; a reservation information output step of outputting reservation guidance data including the authentication information registered in the reservation data when the reservation data is registered in the reservation registering step; a second searching step of searching for an unoccupied seat appropriate for the conditions registered in the reservation data in updated seat data when the seat data is updated; an acquisition step of acquiring authentication information input by the user when a seat appropriate for the conditions is searched in the second searching step; an authentication processing step of determining that the authentication information acquired in the acquisition step has been input by an authorized user when the authentication information acquired in the acquisition step matches the authentication information included in the reservation data; and a guidance output step of outputting information of a seat searched in the first searching step as guidance data when a seat appropriate for the conditions is searched in the first searching step and outputting information of a seat searched in the second searching step as guidance data when an input from the authorized user is authenticated in the authentication processing step.

A user can be correctly guided to a seat by executing authentication of a user guided to a seat.

### BRIEF DESCRIPTION OF THE DRAWINGS

FIG. 1 is a block diagram illustrating the configuration of a seat guiding apparatus according to an example.

FIG. 2 is a data configuration diagram illustrating one example of data used by the seat guiding apparatus illustrated in FIG. 1.

FIG. 3 is a flowchart illustrating one example of a seat guiding process performed in the seat guiding apparatus illustrated in FIG. 1.

FIG. 4 is one example of a screen displayed by the seat guiding apparatus illustrated in FIG. 1.

FIG. 5 is one example of a screen displayed by the seat guiding apparatus illustrated in FIG. 1.

FIG. 6 is one example of a guidance sheet output by the seat guiding apparatus illustrated in FIG. 1.

FIG. 7 is a circuit diagram illustrating the configuration of a seat guiding apparatus according to an example.

FIG. 8 is an external view illustrating a seat guiding apparatus according to a modified example.

### REFERENCE SIGNS LIST

1 Seat guiding apparatus
P Seat guiding program
101 Vacant seat information acquiring unit
102 Conditions receiving unit
103 Searching unit
104 First searching means
105 Second searching means
106 Authentication information generating unit
107 Reservation registering unit
108 Reservation information output unit
109 Detection unit
110 Acquisition unit
111 Authentication processing unit
112 Guidance output unit
113 Seat data updating unit
114 Reservation data updating unit

### DETAILED DESCRIPTION

Hereinafter, a seat guiding apparatus, a seat guiding program, and a seat guiding method according to examples will be described. In the following description, the same reference signs will be used for the same components, and duplicated description thereof will not be given.

The seat guiding apparatus, for example, may be installed at an entrance of a restaurant or the like and output guidance information used to guide a customer visiting this restaurant to an unoccupied seat. When there is no unoccupied seat desired by a customer, this seat guiding apparatus executes a seat reservation and can output information relating to guidance to a reserving person at the time of occurrence of a seat becoming vacant.

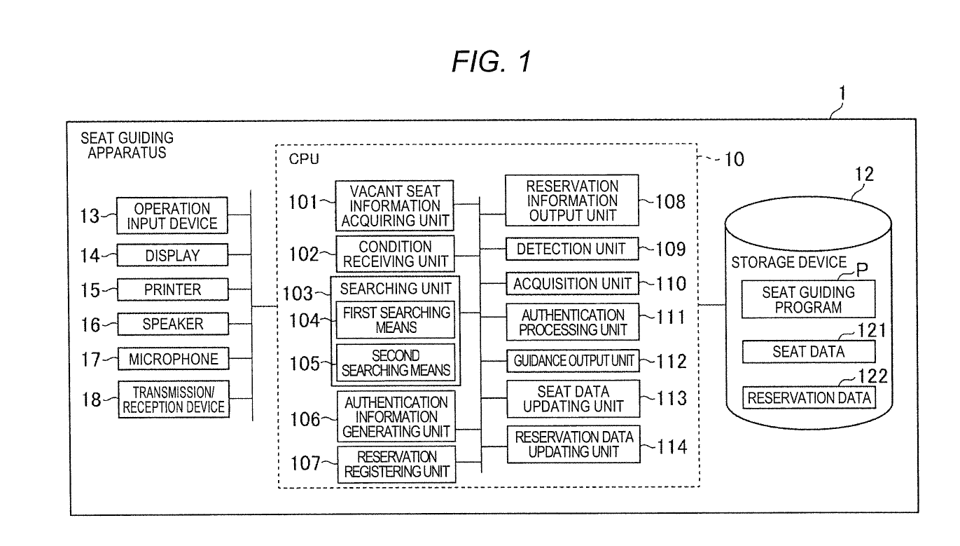

As illustrated in FIG. 1, a seat guiding apparatus 1 according to a first example includes: a vacant seat information acquiring unit 101 acquiring vacant seat information; a conditions receiving unit 102 acquiring conditions for a seat search input by a user; a searching unit 103 searching for a seat that is appropriate for the conditions; an authentication information generating unit 106 setting authentication information used to specify a user; a reservation registering unit 107 registering reservation information of a seat; a reservation information output unit 108 outputting information of a seat reservation; a detection unit 109 detecting occurrence of a seat becoming vacant at the time of occurrence of a seat becoming vacant; an acquisition unit 110 acquiring authentication information input by the user; an authentication processing unit 111 determining whether or not authentication information has been input by a correct user; a guidance output unit 112 outputting information of a seat to which the user is guided; a seat data updating unit 113 updating seat data; and a reservation data updating unit 114 updating reservation data.

More specifically, the seat guiding apparatus 1 according to the example may be an information processing apparatus including a central processing unit (CPU) 10, a storage device 12, an operation input device 13, a display 14, a printer 15, a speaker 16, a microphone 17, a transmission/reception device 18, and the like. In this seat guiding apparatus 1, by executing a seat guiding program P stored by the storage device 12, the CPU 10 executes processes for the vacant seat information acquiring unit 101, the conditions receiving unit 102, the searching unit 103, the authentication information generating unit 106, the reservation registering unit 107, the reservation information output unit 108, the detection unit 109, the acquisition unit 110, the authentication processing unit 111, the guidance output unit 112, the seat data updating unit 113, and the reservation data updating unit 114.

The operation input device 13 has operation buttons or a touch panel used by a user such as a member of staff, a customer or the like of a restaurant for inputting various operation signals. The display 14 is a display device such as a liquid crystal display that displays various guide screens for a user. The printer 15 outputs sheets relating to various guides to a user. The speaker 16 outputs various guides and the like using speech to a user. The microphone 17 is used to input speech data such as various operation signals performed by a user. The transmission/reception device 18 is a communication interface that is used to transmit and receive data.

The storage device 12, for example, is a semiconductor storage device such as a read only memory (ROM), a random access memory (RAM), a compact flash (CF), a secure digital (SD) or the like, a magnetic storage medium such as a flexible disk or the like, or an optical storage medium such as a compact disk read only memory (CD-ROM) or the like. The storage device 12 stores seat data 121 and reservation data 122 together with the seat guiding program P.

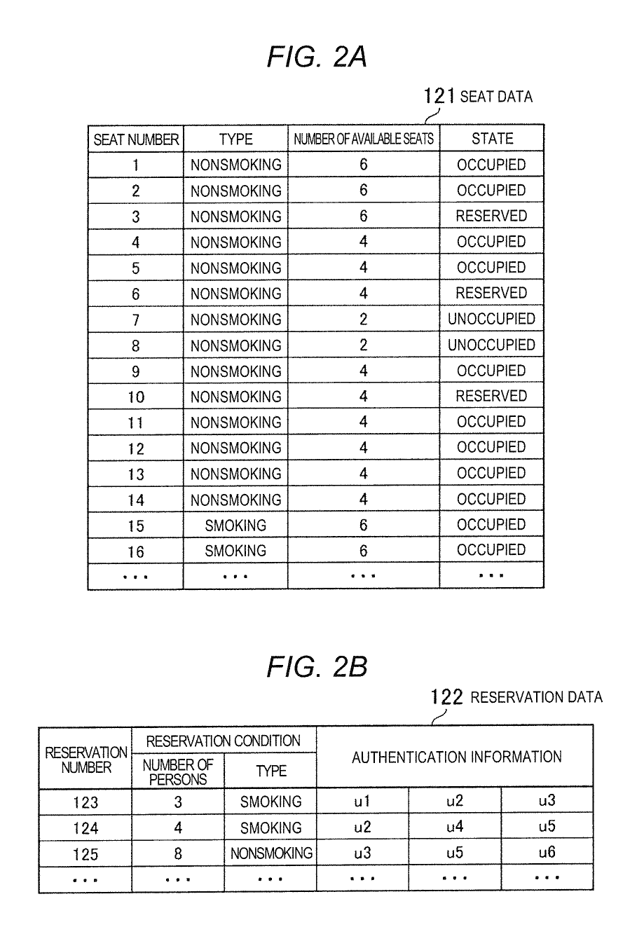

The seat data 121 is data including the state of each seat in a restaurant. More specifically, the seat data 121 is data including information of a state representing whether a seat is vacant or not. For example, as illustrated in FIG. 2(a), the seat data 121 associates “number” specifying a seat, “type” of the seat, “the number of persons” who can sit on the seat, and “state” of the seats with each other. Hereinafter, a “seat” corresponds to a “table” rather than a “chair” in a restaurant. In other words, a “seat” identified by a seat number “1” is a table that can be used by six persons rather than a seat. In addition, a “chair” and a “seat” have the same meaning.

In the example illustrated in FIG. 2(a), there are “smoking” and “nonsmoking” for “type.” In other words, in the example illustrated in FIG. 2(a), tables of seat numbers “1” to “14” are nonsmoking seats, and tables of seat numbers “15” and “16” are smoking seats. In addition, for example, “type” may include various kinds of information representing features of seats such as a counter seat, a table seat, an in-restaurant seat, a terrace seat, a chair seat, a mat seat and the like.

In the example illustrated in FIG. 2(a), a table of a seat number “1” has “the number of sitting persons” as “6” and, accordingly, guiding to this table is performed when seats are requested from a group of six persons or less. In addition, in the example illustrated in FIG. 2(a), there are no seats having “the number of sitting persons” as “7 or more.” Thus, when a group of seven persons or more visits the restaurant, this group is guided to a plurality of tables.

In the example illustrated in FIG. 2(a), for the “states,” there are “occupied,” “reserved,” and “unoccupied.”

In other words, in the example illustrated in FIG. 2(a), it can be understood that the table of the seat number “1” is occupied by customers. In addition, it can be understood that a table of a seat number “3” is reserved.

Furthermore, it can be understood that a table of a seat number “7” is unoccupied. In addition, the “states” are not limited thereto and may include “during payment” and the like other than these.

The reservation data 122 is data including a reservation number specifying the order of reservation, reservation conditions, and authentication information identifying a user. The “reservation number” is given when a reservation is registered.

In the example of the reservation data 122 illustrated in FIG. 2(b), for the “reservation conditions,” “the number of persons” regarding customers desiring to sit at the table and the “type” of the table” are included. In addition, in FIG. 2(b), although an example of the authentication information including identifiers of three types is illustrated, authentication information included in the reservation data 122 is not limited thereto.

In the example illustrated in FIG. 2(b), a reservation of a reservation number “123” is set such that “three persons, nonsmoking seats” are reservation conditions, and “u1,” “u2,” and “u3” are set as authentication information. In addition, a reservation of a reservation number “124” is set such that “four persons, smoking seats” are reservation conditions, and “u2,” “u4,” and “u5” are set as authentication information. Furthermore, a reservation of a reservation number “125” is set such that “eight persons, nonsmoking seats” are reservation conditions, and “u3,” “u5,” and “u6” are set as authentication information.

The vacant seat information acquiring unit 101 acquires vacant seat status data of the restaurant and registers the acquired vacant seat status data in the storage device 12 as seat data 121. In addition, the vacant seat information acquiring unit 101 updates the seat data 121 at a predetermined timing. The predetermined timing, for example, is a timing at which a vacant seat occurs. In addition, when a seat reservation has not been registered in the reservation data 122, the timing at which the conditions receiving unit 102 newly receives conditions may be set as the update timing of the seat data 121. Although the seat data 121 may be updated when conditions are newly received wherein seats have not been reserved in the reservation data 122, it is necessary to acquire vacant seat status data in real time when a reservation has been made.

For example, the seat guiding apparatus 1 is connected to a seat managing system (not illustrated in the drawings) that manages seat information of the inside of the restaurant through a network, and the vacant seat information acquiring unit 101 acquires seat information including vacant seat information of seats from this seat managing system as vacant seat status data. Alternatively, the seat guiding apparatus 1 may include a seat managing unit that manages seat information internally and acquire the vacant seat status from this seat managing unit.

The conditions receiving unit 102 receives conditions of a desired seat input by a customer (hereinafter, referred to as a “user”) requesting an unoccupied seat in the restaurant. In addition, the conditions receiving unit 102 outputs the conditions of a seat to the searching unit 103. More specifically, the conditions receiving unit 102 acquires the conditions of a seat input using the operation input device 13 or the microphone 17. For example, when the seat guiding apparatus 1 uses the seat data 121 illustrated in FIG. 2(a), the “conditions” include the “number of persons” to sit on the desired seat and selection of one of a “nonsmoking seat” and a “smoking seat.” In addition, the “conditions” are not limited thereto and may be only “the number of persons” or only the type of table or may include a certain desired condition.

The searching unit 103 includes a first searching means 104 and a second searching means 105 searching for unoccupied seats appropriate for conditions desired by the user.

When conditions are input from the conditions receiving unit 102, the first searching means 104 searches for an unoccupied seat appropriate for the conditions received by the conditions receiving unit 102 by referring to the seat data 121 stored by the storage device 12. In addition, the first searching means 104 outputs a number of the searched seat to the guidance output unit 112. When there are no seats appropriate for the conditions, the first searching means 104 outputs the conditions of the seat to the authentication information generating unit 106.

When an update of the seat data 121 is detected by the detection unit 109, the second searching means 105 searches for an unoccupied seat appropriate for the conditions included in the reservation data 122 and outputs a number of the searched seat to the acquisition unit 110.

More specifically, the second searching means 105 specifies reservation conditions of a search target from the reservation data 122. When a plurality of reservations are registered in the reservation data 122, a reservation number registered first is specified as a search target. In addition, the second searching means 105 searches for an unoccupied seat appropriate for the condition of the reservation number specified as the search target from the seat data 121. Thereafter, the second searching means 105 extracts authentication information associated with the reservation number that is the search target in the reservation data 122 and outputs the reservation number that is the search target, the seat number acquired as a result of the search, and the extracted authentication information to the acquisition unit 110.

In addition, when a plurality of reservations are registered in the reservation data 122, and a seat for conditions of a reservation that has been registered first is not searched, the second searching means 105 can search for a seat for conditions registered next.

When conditions are input from the first searching means 104, the authentication information generating unit 106 sets authentication information specifying a user. In addition, the authentication information generating unit 106 outputs the set authentication information to the reservation registering unit 107 together with the input conditions. Although a method of setting authentication information used by the authentication information generating unit 106 is not particularly limited, it is preferable the authentication information be different from other authentication information included in the reservation data 122. In addition, the authentication information, for example, may be a password configured of a plurality of characters, image data, or a combination of a plurality of pieces of image data. In addition, when image data is used for authentication, an identifier specifying image data is set as authentication information. This authentication information is generated for user authentication.

When conditions and authentication information are input from the authentication information generating unit 106, the reservation registering unit 107 registers the conditions and the authentication information, which have been input, in the storage device 12 together with a reservation number specifying the order of the reservation as reservation data 122. In addition, the reservation registering unit 107 outputs the reservation number, the conditions, and the authentication information that have been registered to the reservation information output unit 108.

When the reservation number, the conditions, and the authentication information are input from the reservation registering unit 107, the reservation information output unit 108 outputs reservation guidance data including the reservation number and the authentication information. For example, the reservation information output unit 108 can output a reservation sheet including information relating to reservation guidance from the printer 15. Alternatively, the reservation information output unit 108 can output speech data including information relating to the reservation guidance from the speaker 16. The output of the reservation sheet from the printer 15 and the output of the speech data from the speaker 16 may be simultaneously performed. In addition, for example, the reservation information output unit 108 may transmit electronic data including the information relating to the reservation guidance to a communication terminal held by the user through the transmission/reception device 18. At this time, a method of communication between the seat guiding apparatus 1 and the communication terminal of the user is not particularly limited and may use either a communication network such as the Internet or short-distance radio communication. In addition, the reservation information output unit 108 may display a display screen including the reservation guidance data on the display 14.

The detection unit 109 detects an update of the seat data 121. In addition, the detection unit 109 notifies the second searching means 105 of detection of an update of the seat data 121.

When a reservation number, a seat number, and authentication information (hereinafter referred to as “registered authentication information”) are input from the second searching means 105, the acquisition unit 110 acquires authentication information input by the user (hereinafter referred to as “input authentication information”). In addition, the acquisition unit 110 outputs the acquired input authentication information and the seat number and the registered authentication information input from the second searching means 105 to the authentication processing unit 111.

For example, the acquisition unit 110, together with notifying a user of an indication of a seat becoming unoccupied by displaying an authentication information input screen including the reservation number on the display 14, can acquire input authentication information input from the user through the operation input device 13 or the microphone 17 by urging an input of the authentication information. In addition, for example, the acquisition unit 110 can acquire input authentication information input from the user through the operation input device 13 by urging the user to input authentication information through the speaker 16 together with notifying of an indication of being unoccupied of a reserved seat reserved with the input reservation number. Furthermore, the acquisition unit 110 may acquire input authentication information through a user's communication terminal by urging the user to input authentication information together with notifying a communication terminal held by the user of an indication of a desired seat being unoccupied through the transmission/reception device 18. At this time, the reservation registering unit 107 needs to have identification information used for communication of the user's communication terminal. In addition, the acquisition unit 110 may use a plurality of the methods described above together. In other words, since it is difficult to notify a user only through display on the display 14, the user can be notified through output of speech data using the speaker 16 or transmission of data to the communication terminal together with the display on the display 14.

When a seat number, registered authentication information, and input authentication information are input from the acquisition unit 110, the authentication processing unit 111 executes an authentication process. More specifically, when the input authentication information acquired by the acquisition unit 110 matches the registered authentication information included in the reservation data 122, the authentication processing unit 111 authenticates that the input has been made from an authorized user. In addition, when the input is authenticated as being input from an authorized user, the authentication processing unit 111 outputs a seat number to the guidance output unit 112.

The guidance output unit 112 extracts information of a seat searched from the searching unit 103 from the seat data 121 and outputs the extracted information as guidance data. More specifically, when a seat number is input from the first searching means 104, the guidance output unit 112 extracts information a seat of this seat number from the seat data 121 and outputs the extracted data as guidance data. In addition, when a seat number is input from the authentication processing unit 111, the guidance output unit 112 extracts information of a seat of this seat number from the seat data 121 and outputs the extracted information as guidance data.

For example, the user can be guided to a seat by outputting the guidance data by combining the display 14, the printer 15, the speaker 16, and the user's communication terminal. More specifically, the guidance output unit 112 can cause the display 14 to display a guide screen including the seat number.

In addition, the guidance output unit 112 can cause the printer 15 to print a guidance sheet including the seat number. Furthermore, the guidance output unit 112 can cause the speaker 16 to output guidance data of speech including the seat number. Other than that, the guidance output unit 112 can transmit electronic data including the seat number to the user's terminal through the transmission/reception device 18. At this time, for example, together with displaying a guide screen on the display 14, a guidance sheet may be output using the printer 15.

When the guidance output unit 112 outputs the guidance data, the seat data updating unit 113 changes the state of the seat to which the user has been guided using the guidance data to being occupied, thereby updating the seat data 121 stored in the storage device 12.

When the guidance output unit 112 outputs the information of the seat searched by the second searching means 105 as guidance data, the reservation data updating unit 114 updates the reservation data 122 stored in the storage device 12 by deleting the authentication information and the conditions of the user for whom the guidance data has been provided.

### Process of Seat Guiding

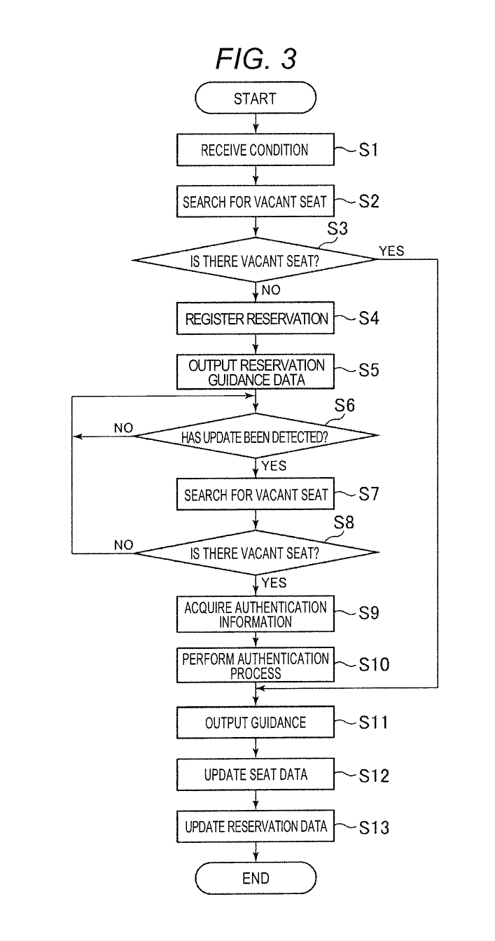

A seat guiding process in the seat guiding apparatus 1 according to the first example will be described using a flowchart illustrated in FIG. 3.

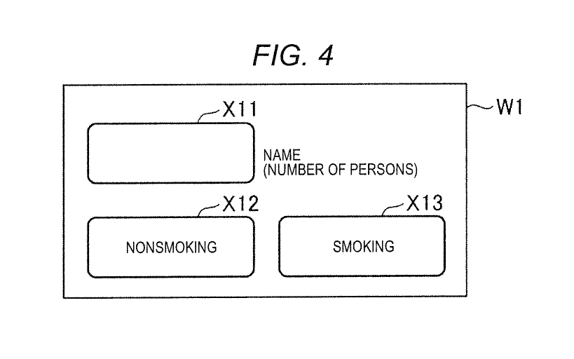

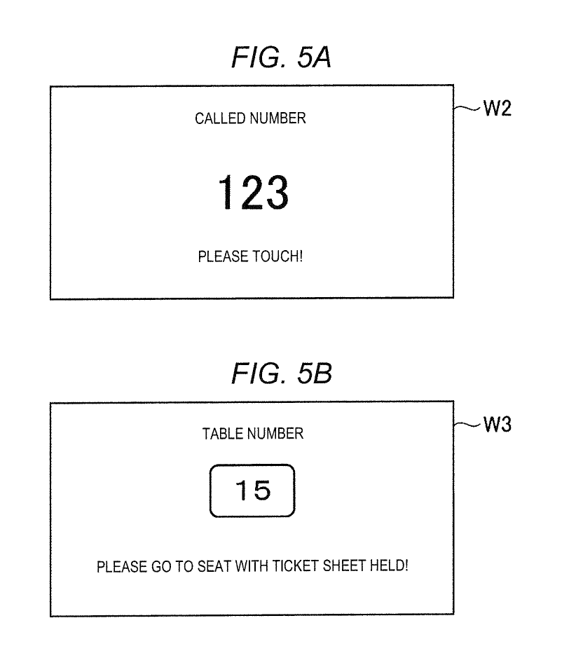

The seat guiding apparatus 1 receives conditions input by a user visiting the restaurant (S1). For example, the seat guiding apparatus 1 displays a condition input screen W1 as illustrated in FIG. 4 on the display 14. In addition, the seat guiding apparatus 1 receives the conditions input by the user through the operation input device 13. As illustrated in FIGS. 4 and 5, it is assumed that the operation input device 13 is a touch panel integrated with the display 14 in description.

FIG. 4 illustrates one example of a condition input screen W1 for allowing a user visiting the restaurant to input desired conditions of “the number of customers” and “smoking or nonsmoking.” The condition input screen W1 illustrated in FIG. 4 includes a condition input section x11 to which a condition of the number of persons is input. The seat guiding apparatus 1 sets information of the number of persons input to the condition selecting section x11 as a condition of a seat desired by the user. For example, the seat guiding apparatus 1 can allow the user to select the number of persons by displaying a plurality of numbers as the user touches on the condition input section x11. In addition, for example, the seat guiding apparatus 1 may further include an operation input device 13 of numeric keys and allow a user to select the number of persons using the operation input device 13.

In addition, the condition input screen W1 illustrated in FIG. 4 includes a condition selecting section x12 to select a desire of a nonsmoking seat and a condition selecting section x13 to select a desired of a smoking seat. Accordingly, the seat guiding apparatus 1 sets a nonsmoking seat as a condition desired by the user when the condition selecting section x12 is selected and sets a smoking seat as a condition desired by the user when the condition selecting section x13 is selected. In addition, the condition input screen W2 may include a selection section to select that either a nonsmoking seat or a smoking seat is good in addition to the condition selecting sections x12 and x13 illustrated in FIG. 4.

For example, the seat guiding apparatus 1 may display the condition input screen W1 on the display 14 as an initial screen. In addition, the seat guiding apparatus 1 may display the condition input screen W1 when an operation desiring a condition input is performed on another initial screen displayed on the display 14. Screen data used to display the condition input screen W1 on the display 14, for example, is included in the seat guiding program P.

In addition, the seat guiding apparatus 1 can receive an input of conditions corresponding to a seat that can be provided by a restaurant. Accordingly, the seat guiding apparatus 1, for example, may display a condition input screen to input a condition of a ratio between the number of adults and the number of children or a condition input screen for inputting a condition of a desire to visit the restaurant using a wheelchair.

When the conditions are input in Step S1, the seat guiding apparatus 1 reads seat data 121 stored in the storage device 12 and searches for unoccupied seats appropriate for the input conditions (S2).

When an unoccupied seat that is appropriate for the conditions is not searched (No in S3), the seat guiding apparatus 1 assigns authentication information specifying the user and registers the assigned authentication information in the reservation data 122 together with the conditions input in Step S1 (S4).

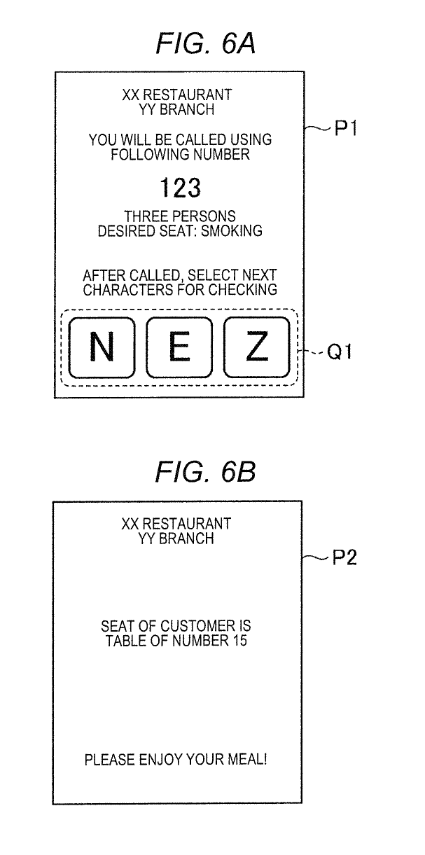

In addition, the seat guiding apparatus 1 outputs reservation guidance data including the authentication information (S5). For example, the seat guiding apparatus 1 causes the printer 15 to output the reservation guidance sheet P1 as illustrated in FIG. 6(a) as one example. In addition, the seat guiding apparatus 1 may display a guide urging the user to receive the reservation guidance sheet P1 on the display 14.

A reservation guidance sheet P1 illustrated in FIG. 6(a) includes authentication information in an authentication information display section q1. The example illustrated in FIG. 6(a) is one example in which a plurality of characters are set as authentication information. More specifically, letters “N,” “E,” and “Z” are set as authentication information. Other than that, the reservation guidance sheet P1 illustrated in FIG. 6(a) includes a call number used to call when a seat appropriate for the conditions becomes unoccupied and the conditions as reservation guidance data. In addition, when the seat guiding apparatus 1 includes a calculating means that calculates a predicted waiting time until calling, the predicted waiting time acquired by the calculating means may be included in the reservation guidance data. Data used to display the reservation guidance sheet P1, for example, is included in the seat guiding program P.

Thereafter, when an update of the seat data 121 is detected (S6), the seat guiding apparatus 1 searches for an unoccupied seat appropriate for the conditions included in the reservation data 122 stored in the storage device 12 (S7).

When an unoccupied seat appropriate for the conditions is searched (Yes in S8), the seat guiding apparatus 1 acquires authentication information from the user (S9). For example, the seat guiding apparatus 1 outputs speech data to call a user using a call number by using the speaker 16 and displays a calling screen W2 as illustrated in FIG. 5(a) on the display 14. The calling screen W2 illustrated in FIG. 5(a) includes a call number “123.” In addition, when the calling screen W2 is displayed on the display 14 integrated with a touch panel that is the operation input device 13, when a user's finger touches on the calling screen W2 displaying this calling screen W2, the seat guiding apparatus 1 displays an authentication screen (not illustrated in the drawing) used to allow a called user to input authentication information on the display 14. In the example using the authentication information illustrated in FIG. 6(a) described above, the seat guiding apparatus 1 displays an authentication screen to select or input a plurality of alphabets on the display 14. In addition, the input of authentication information is not limited to be performed only on the screen, but a separate input unit may be configured for the input thereof.

Subsequently, the seat guiding apparatus 1 executes an authentication process (S10). More specifically, when the authentication information acquired in the authentication information acquiring process of Step S9 is identical to the authentication information included in the reservation guidance data output in Step S5, the seat guiding apparatus 1 determines that the authentication information has been acquired from an authorized user. On the other hand, when the authentication information acquired in the authentication information acquiring process of Step S9 is not identical to the authentication information included in the reservation guidance data output in Step S5, the seat guiding apparatus 1 determines that the authentication information has been input by a person other than the authorized user. Screen data used to display the calling screen W2 or the like on the display 14, for example, is included in the seat guiding program P. In addition, when the authentication information is not identical to each other, the seat guiding apparatus 1 allows the user to input authentication information again or executes calling again to call the authorized user, and the process thereof will not be described here.

After searching an unoccupied seat in Step S3 or ending the authentication process in which it is determined that the authentication information has been acquired from the authorized user in Step S10, the seat guiding apparatus 1 outputs guidance data of the seat (S11). For example, the seat guiding apparatus 1 displays a seat guide screen W3 as illustrated in FIG. 5(b) as one example on the display 14. In addition, the seat guiding apparatus 1 causes the printer 15 to output a seat guidance sheet P2 as illustrated in FIG. 6(b) as one example.

The seat guide screen W3 illustrated in FIG. 5(b) notifies a user of a number of the table and urges the user to receive the seat guidance sheet P2. The screen data used to display the seat guide screen W3 on the display 14, for example, is included in the seat guiding program P. In addition, the seat guidance sheet P2 illustrated in FIG. 6(b) includes a number of the table.

When the guidance data is output in Step S11, the seat guiding apparatus 1 updates the seat data 121 stored in the storage device 12 (S12).

In addition, the seat guiding apparatus 1 updates the reservation data 122 stored in the storage device 12 (S13). The order of the processes of Steps S12 and S13 may be reversed, or the processes may be executed in parallel.

In addition, in the search of Step S7, when a seat with conditions of which a reservation is registered first is not searched (No in S8), the seat guiding apparatus 1 may search a seat with conditions registered next. For example, when a condition registered first is a nonsmoking seat, and a condition registered next is a smoking seat, when a smoking seat is unoccupied, the seat guiding apparatus 1 may guide a user who registers a reservation later. In this example, when the guidance data is output in Step S11, it is necessary to output that the guiding order is reversed to a user who has registered a reservation earlier such that the user can be noticed thereof. In other words, the reason for this is to prevent a user who has made a reservation earlier from having distrust in the seat guiding apparatus 1 and the restaurant in accordance with guidance to a user who has registered a reservation later that is performed first.

As described above, according to the seat guiding apparatus 1 of the first example, even when a user cannot be immediately guided to a seat by a restaurant staff when the user visits a store, the user can be guided to a seat by searching seats of conditions desired by the user. In addition, when there is no unoccupied seat with the desired conditions, by registering reservation information together with authentication information used to authenticate the user, when a state being able to guide the user to a seat is formed, the user can be guided to the seat.

In the example described above, each process in the seat guiding apparatus 1 has been described as being realized by the CPU 10 executing the seat guiding program P. On the other hand, in the seat guiding apparatus 1, each process may be realized by a logic circuit (hardware) or a dedicated circuit formed in an integrated circuit (integrated circuit (IC) chip, a large scale integration (LSI)), a field programmable gate array (FPGA), a complex programmable logic device (CPLD) or the like instead of the CPU 10. In addition, such a circuit may be realized by one or a plurality of integrated circuits, or the functions of a plurality of functional units illustrated in the example described above may be realized by one integrated circuit. The LSI may be also referred to as a VLSI, a super LSI, an ultra LSI or the like depending on the degree of integration.

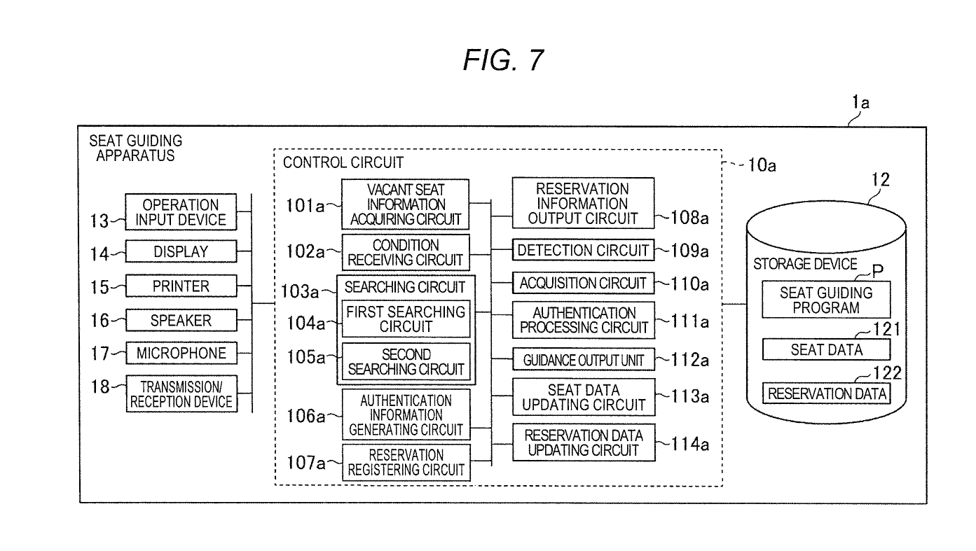

In other words, as illustrated in FIG. 7, the seat guiding apparatus 1 may be composed of a control circuit 10a, a storage device 12, an operation input device 13, a display 14, a printer 15, a speaker 16, a microphone 17, and a transmission/reception device 18. The control circuit 10a includes: a vacant seat information acquiring circuit 101a; a condition receiving circuit 102a; a searching circuit 103a including a first searching circuit 104a and a second searching circuit 105a; an authentication information generating circuit 106a; a reservation registering circuit 107a; a reservation information output circuit 108a; a detection circuit 109a; an acquisition circuit 110a; an authentication processing circuit 111a; a guidance output circuit 112a; a seat data updating circuit 113a; and a reservation data updating circuit 114a. In addition, the storage device 12 stores the seat guiding program P, the seat data 121, and the reservation data 122. The circuits 101a to 114a are controlled by the seat guiding program P. The function of each of the circuits is similar to that of each unit having the same name illustrated in the example described above.

In addition, as the storage device 12, “a medium of a non-transitory type,” for example, a tape, a disk, a card, a semiconductor memory, a programmable logic circuit, or the like may be used.

Furthermore, the search program described above may be supplied to the processor described above through an arbitrary transmission medium (a communication network, a broadcast wave, or the like) that can transmit the search program. Our system may be realized also in a form of data signals embedded in a carrier wave implemented by electronic transmission of the video display program.

In addition, the program described above may be implemented, for example, using a script language such as ActionScript, JavaScript (registered trademark), Python, Ruby, or the like, a complier language such as a C language, C++, C#, Objective-C, or Java (registered trademark), an assembly language, a register transfer level (RTL), or the like.

### OTHER EXAMPLES

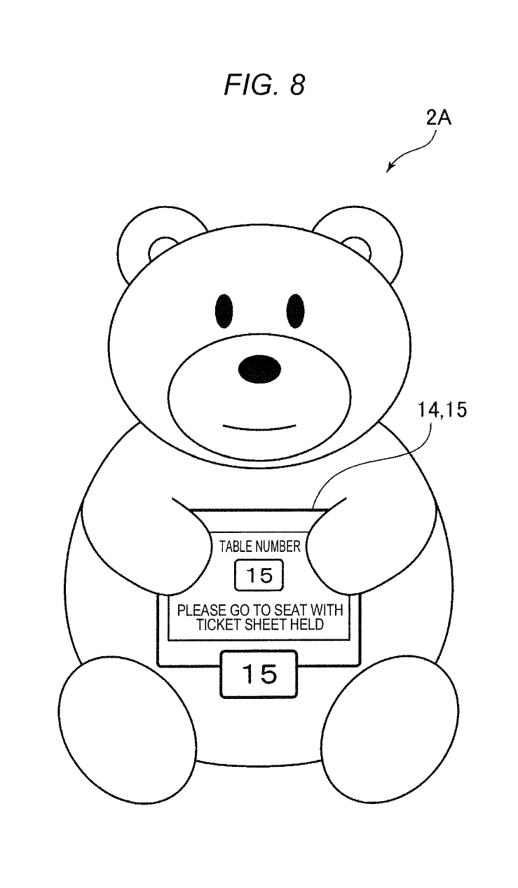

In addition, as illustrated in FIG. 8, by arranging the display 14 or the printer 15 of the seat guiding apparatus 1 to be held by a robot 2A having a shape of a person, an animal or the like, inputting or waiting can be enjoyable without giving an impression of a mechanical operation to a user. In other words, instead of performing an input of conditions and guiding a seat using only machines such as an input device, an output device and the like, by arranging the input device or the output device in a person-shaped or animal-shaped robot, a feeling like transmitting conditions of a seat to a robot and guiding a user to a seat from the robot can be acquired.

In addition, a user may be allowed to make a reservation before visiting the store. In the example described above, a seat has been described to be reserved by a user visiting a restaurant and inputting desired conditions to the seat guiding apparatus 1 installed in the restaurant. However, a reservation may be received from a user before visiting the restaurant and be registered in the reservation data 122, and reservation guidance data including a reservation number and authentication information may be directly received by a terminal of the user. In such an example, the user can easily specify a seat for a meal accurately using the reservation information and the authentication information included in the reservation guidance data when visiting the store.

1-10. (canceled)

11. A seat guiding apparatus comprising:
a conditions receiving unit that receives conditions of a desired seat input by a user requesting an unoccupied seat in a restaurant;
a first searching unit that searches for an unoccupied seat appropriate for the conditions received by the conditions receiving unit by referring to seat data including a state of each seat in the restaurant;
a reservation registering unit that registers reservation data including authentication information given to authenticate the user and the conditions when a seat appropriate for the conditions is not searched by the first searching unit;
a reservation information output unit that outputs reservation guidance data including the authentication information registered in the reservation data when the reservation registering unit registers the reservation data;
a second searching unit that searches for an unoccupied seat appropriate for the conditions registered in the reservation data in updated seat data when the seat data is updated;
an acquisition unit that acquires authentication information input by the user when a seat appropriate for the conditions is searched by the second searching unit;
an authentication processing unit determining that the authentication information acquired by the acquisition unit has been input by an authorized user when the authentication information acquired by the acquisition unit matches the authentication information included in the reservation data; and
a guidance output unit that outputs information of a seat searched by the first searching unit as guidance data when a seat appropriate for the conditions is searched by the first searching unit and outputs information of a seat searched by the second searching unit as guidance data when an input from the authorized user is authenticated by the authentication processing unit.

12. The seat guiding apparatus according to claim 11, further comprising a seat data updating unit that updates the seat data by changing a state of the seat to which the user is guided as being occupied in the guidance data when the guidance output unit outputs the guidance data.

13. The seat guiding apparatus according to claim 11, further comprising a reservation data updating unit that updates the reservation data by deleting the authentication information and the conditions of the user for whom the guidance data has been provided when the guidance output unit outputs the information of the seat searched by the second searching unit as the guidance data.

14. The seat guiding apparatus according to claim 11, further comprising a detection unit that detects an update of the seat data and notifies the second searching unit of the update of the seat data.

15. The seat guiding apparatus according to claim 11,
wherein the reservation registering unit registers reservation data including a reservation number that specifies an order of a reservation, and
the second searching unit sets a seat for conditions specified for a reservation that has been registered first using the reservation number included in the reservation data as a search target.

16. The seat guiding apparatus according to claim 11, further comprising an authentication information generating unit that generates authentication infoiriiation used to authenticate the user and outputs the generated authentication information to the reservation information output unit when a seat appropriate for the conditions is searched by the second searching unit.

17. The seat guiding apparatus according to claim 11, wherein the reservation information output unit prints reservation information on a reservation sheet, transmits electronic data including the reservation information to a terminal of the user, or displays a display screen including the reservation information on a display.

18. The seat guiding apparatus according to claim 11, wherein the guidance output unit prints guidance data on a guidance sheet, transmits electronic data including the guidance information to a terminal of the user, displays a display screen including the guidance information on a display, or outputs speech data including the guidance information from a speaker.

19. The seat guiding apparatus according to claim 11, wherein the information of the seat of the guidance data is a seat number of the seat in the restaurant.

20. A seat guiding program causing a computer of a seat guiding apparatus to execute:
a condition receiving function of receiving conditions of a desired seat input by a user requesting an unoccupied seat in a restaurant;
a first searching function of searching for an unoccupied seat appropriate for the conditions received by the condition receiving function by referring to seat data including a state of each seat in the restaurant;
a reservation registering function of registering reservation data including authentication information given for authentication of the user and the conditions when a seat appropriate for the conditions is not searched by the first searching function;
a reservation information output function of outputting reservation guidance data including the authentication information registered in the reservation data when the reservation registering function registers the reservation data;
a second searching function of searching for an unoccupied seat appropriate for the conditions registered in the reservation data in updated seat data when the seat data is updated;
an acquisition function of acquiring authentication information input by the user when a seat appropriate for the conditions is searched by the second searching function;
an authentication processing function of determining that the authentication information acquired by the acquisition function has been input by an authorized user when the authentication information acquired by the acquisition function matches the authentication information included in the reservation data; and
a guidance output function of outputting information of a seat searched by the first searching function as guidance data when a seat appropriate for the conditions is searched by the first searching function and outputting information of a seat searched by the second searching function as guidance data when an input from the authorized user is authenticated by the authentication processing function.

21. A seat guiding method executed by a computer, the seat guiding method comprising:
a condition receiving step of receiving conditions of a desired seat input by a user requesting an unoccupied seat in a restaurant;
a first searching step of searching for an unoccupied seat appropriate for the conditions received in the condition receiving step by referring to seat data including a state of each seat in the restaurant;
a reservation registering step of registering reservation data including authentication information given to authenticate the user and the conditions when a seat appropriate for the conditions is not searched in the first searching step;
a reservation information output step of outputting reservation guidance data including the authentication information registered in the reservation data when the reservation data is registered in the reservation registering step;
a second searching step of searching for an unoccupied seat appropriate for the conditions registered in the reservation data in updated seat data when the seat data is updated;
an acquisition step of acquiring authentication information input by the user when a seat appropriate for the conditions is searched in the second searching step;
an authentication processing step of determining that the authentication information acquired in the acquisition step has been input by an authorized user when the authentication information acquired in the acquisition step matches the authentication information included in the reservation data; and
a guidance output step of outputting information of a seat searched in the first searching step as guidance data when a seat appropriate for the conditions is searched in the first searching step and outputting information of a seat searched in the second searching step as guidance data when an input from the authorized user is authenticated in the authentication processing step.
